(19) United States
(12) Patent Application Publication
(10) Pub. No.: US 2026/0225439 A1
(43) Pub. Date: Aug. 6, 2026

(54) TRACKED COMPACT ALL-TERRAIN VEHICLE WITH ELECTROMECHANICAL TRANSMISSION

(71) Applicant: GLOBAL TERRANICA LIMITED LIABILITY COMPANY, Moscow (RU)

(72) Inventor: Sergey Aleksandrovich SELEZNEV, Moscow (RU)

(21) Appl. No.: 19/154,310

(22) PCT Filed: Sep. 14, 2023
(86) PCT No.: PCT/RU2023/000269

§ 371 Date: Aug. 6, 2025

(30) Foreign Application Priority Data
Aug. 23, 2023 (RU) 2023122002

(51) Int. Cl. B60K 6/46; B60K 15/063; B60K 17/12; B62D 55/06

(52) U.S. Cl. CPC B60K 6/46; B60K 15/063; B60K 17/12; B62D 55/06

(57) ABSTRACT

The invention relates to transport machinery and, in particular, to all-terrain vehicles (ATVs); snow and swamp-going vehicles. A small-sized tracked ATV with electromechanical transmission characterized in that it comprises a power frame, caterpillar movers, as well as the following installed on the power frame and connected to each other: an ICE generator, which is in turn connected to two gasoline tanks; two traction electric motors, each of which is connected to its own traction inverter; an energy accumulator and a control unit, wherein the power frame comprises a floor, a roof and walls forming a common internal useful displacement volume combined with additional useful displacement volumes located on both sides of the common internal useful displacement volume in the caterpillar contour of the movers, and the electric motors are installed in the front part of the power frame in a block with gearboxes and are connected by the cardan drive to the driving wheel assembly to organize the front drive of the caterpillar mover or are installed outside the front part of the power frame and are made directly as the electric motor wheels to serve as the driving wheels, with the ICE generator installed entirely in the additional useful displacement volume of one of the caterpillar contours, while the energy accumulator is installed entirely in the opposite useful displacement volume of the other caterpillar contour and, in terms of its weight, is equal to the ICE generator, wherein the gasoline tanks are installed entirely in both useful displacement volumes of the caterpillar contours of the movers, and have the same design, the same capacity and the same overflow system. Technical result: simplified design and increased reliability, reduced weight and dimension characteristics, capacity to travel at high maximum speed, far away from filling stations and in any weather conditions, optimal weight distribution and expanded usable space to accommodate the crew and cargo, increased mileage between overhauls and lower labor costs for repair and maintenance. 9 dependent claims, 7 figures

### TECHNICAL FIELD

The invention relates to transport machinery and, in particular, to all-terrain vehicles (ATVs); snow and swamp-going vehicles.

### PRIOR ART

The prior art discloses a tracked all-terrain production machine comprising an amphibious chassis in the form of a displacement hull with a cabin for driver/operator, caterpillar movers, an engine compartment located in the displacement hull, production equipment made with autonomous control and designed as lifting, and/or earthmoving, and/or drilling, and/or pumping equipment, wherein the hydraulic system of production equipment is connected by hydraulic pipes to a hydraulic pump mounted on the transfer gearbox of the chassis and is equipped with propellers or water jets.

Also, the prior art discloses an ATV (RU2549300C1, Apr. 27, 2015) comprising a boat hull, an internal combustion engine (ICE), wheels, lever and spring suspension to the wheels, a winch, a hydraulic drive of the ATV propulsion system on water, a driver's cabin with an ATV control system, a passenger compartment, doors at the rear of the passenger compartment, wherein a power frame is located inside the boat hull, on which a multi-fuel diesel engine with a hydraulic pump station is located, power units and a water jet, front and rear mechanisms used for radial lifting of wheel blocks and driven by hydraulic motors for lowering and lifting the wheel blocks are mounted outside the left and right sides of the hull and secured to the power frame, the left and right wheel blocks are identical structures consisting of bearing traverses mounted pivotally on the radial lifting mechanisms, wherein each traverse has four mounted independent spring/hydraulic suspensions of the wheels consisting of a system of levers arranged in parallel to the traverse, and the housing of a centrifugal hydraulic motor with a wheel hub is secured to the base of the lower lever, wherein the torque power is transmitted by hydraulic fluid through a pipeline system to the hydraulic motors of all wheels, to the hydraulic motor of the water jet, to the hydraulic motors of the actuating mechanisms, and the distribution, intensity and direction of the hydraulic fluid flow to the hydraulic motors of the actuating mechanisms is provided by a control system with computer programming.

A disadvantage of above solutions is their overly complex and unreliable design, which is laden with a great number of additional devices and has a large number of mechanical links; in addition, these solutions have increased weight and dimension characteristics, their weight distribution is not correct, they are not designed to operate at a high maximum speed and far away from filling stations, they have reduced mileage between overhauls, require significant labor costs for repair and maintenance, and have insufficient usable space to accommodate the crew and cargo.

### SUMMARY OF INVENTION

The technical task is to create a small-sized, reliable and simply designed ATV, which has a minimum number of mechanical links, low weight and dimension characteristics, is intended for traveling at high maximum speed, far away from filling stations and in any weather conditions, has reduced mileage between overhauls and requires no significant labor costs for repair and maintenance, and has the optimal weight distribution and sufficient usable space to accommodate the crew and cargo.

Technical result: simplified design and increased reliability, reduced weight and dimension characteristics, capacity to travel at high maximum speed, far away from filling stations and in any weather conditions, optimal weight distribution and expanded usable space to accommodate the crew and cargo, increased mileage between overhauls and lower labor costs for repair and maintenance.

This technical result is achieved by the fact that the small-sized tracked ATV with electromechanical transmission comprises a power frame, caterpillar movers, as well as the following installed on the power frame and connected to each other: an ICE generator, which is in turn connected to two gasoline tanks; two traction electric motors, each of which is connected to its own traction inverter; an energy accumulator and a control unit, wherein the power frame comprises a floor, a roof and walls forming a common internal useful displacement volume combined with additional useful displacement volumes located on both sides of the common internal useful displacement volume in the caterpillar contour of the movers, and the electric motors are installed in the front part of the power frame in a block with gearboxes and are connected by the cardan drive to the driving wheel assembly to organize the front drive of the caterpillar mover or are installed outside the front part of the power frame and are made directly as the electric motor wheels to serve as the driving wheels, with the ICE generator installed entirely in the additional useful displacement volume of one of the caterpillar contours, while the energy accumulator is installed entirely in the opposite useful displacement volume of the other caterpillar contour and, in terms of its weight, is equal to the ICE generator, wherein the gasoline tanks are installed entirely in both useful displacement volumes of the caterpillar contours of the movers, and have the same design, the same capacity and the same overflow system.

In addition, the ICE generator, traction electric motors and energy accumulator are electrically connected to each other through a high-voltage switching device by means of a CAN bus and control wires.

In addition, the high-voltage switching device has an insulation monitoring system which continuously measures the insulation resistance and sends the measurement values to the CAN bus.

In addition, only two traction electric motors/gearboxes are mechanically linked, while all other transmission elements are linked exclusively via CAN bus and control wires.

In addition, the ICE generator is connected to the high-voltage switching device via an AC-DC converter.

In addition, a DC-AC inverter is further connected to the high-voltage switching device.

In addition, the energy accumulator has a Battery Management System (BMS).

In addition, the energy accumulator has a thermal management unit.

In addition, the small-sized tracked ATV with electromechanical transmission is further equipped with a low-voltage switching device, which is connected on the one side to the main control unit and controls and, on the other side, to the high-voltage switching device via a DC-DC converter combined with the on-board charger unit.

In addition, the common internal useful displacement volume combined with the additional useful displacement volume, which is located in the caterpillar contour of the movers, is fully protected against the penetration of dust and water.

### BRIEF DESCRIPTION OF THE DRAWINGS

FIG. 1. Main elements of ATV design with traction electric motors installed in the front part of the power frame in a block with gearboxes and connected to the cardan drive of the driving wheel assembly, isometric view;

FIG. 2. Main elements of ATV design with traction electric motors installed in the front part of the power frame in a block with gearboxes and connected to the cardan drive of the driving wheel assembly, top view;

FIG. 3. Main elements of ATV design with traction electric motors installed in the front part of the power frame in a block with gearboxes and connected to the cardan drive of the driving wheel assembly, front view;

FIG. 4. Main elements of ATV design with traction electric motors installed outside the front part of the power frame and made in the form of electric motor wheels to serve directly as the driving wheels, isometric view;

FIG. 5. Main elements of ATV design with traction electric motors installed outside the front part of the power frame and made in the form of electric motor wheels to serve directly as the driving wheels, top view;

FIG. 6. Main elements of ATV design with traction electric motors installed outside the front part of the power frame and made in the form of electric motor wheels to serve directly as the driving wheels, front view;

FIG. 7. Circuit diagram of design elements.

The following elements are indicated in the figures:
1. ICE generator;
2. Gasoline tanks;
3. Traction electric motor;
4. Energy accumulator (rechargeable battery);
5. Gearbox;
6. Driving wheel;
7. Traction inverter;
8. Control unit;
9. Thermal management unit of the energy accumulator;
10. High-voltage switching device;
11. AC-DC converter;
12. DC-AC inverter;
13. Low-voltage switching device;
14. Instrument cluster;
15. CAN logger;
16. DC-DC converter;
17. On-board charger unit.

### EMBODIMENT OF THE INVENTION

The claimed small-sized tracked ATV with electromechanical transmission comprises a power frame, caterpillar movers, as well as the following installed on the power frame and connected to each other: ICE generator 1 (a generator module comprising an internal combustion engine that rotates a synchronous permanent magnet AC generator), which is in turn connected to two gasoline tanks 2; two traction electric motors 3, each of which is connected to its traction inverter 7; the energy accumulator (rechargeable battery) 4 and control unit 8.

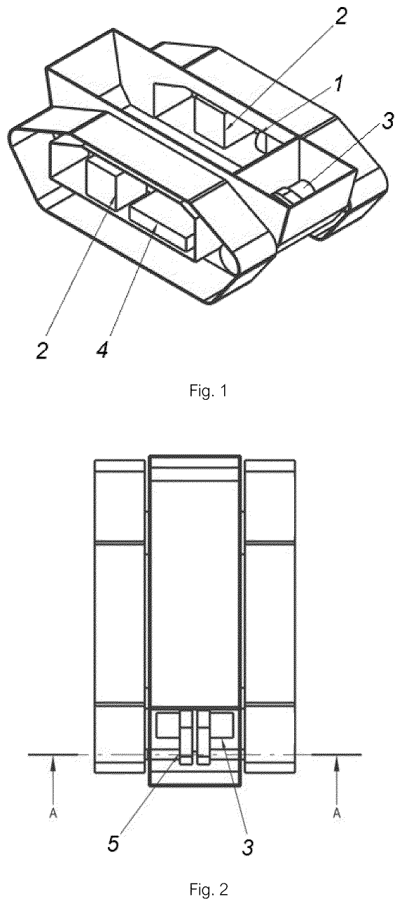

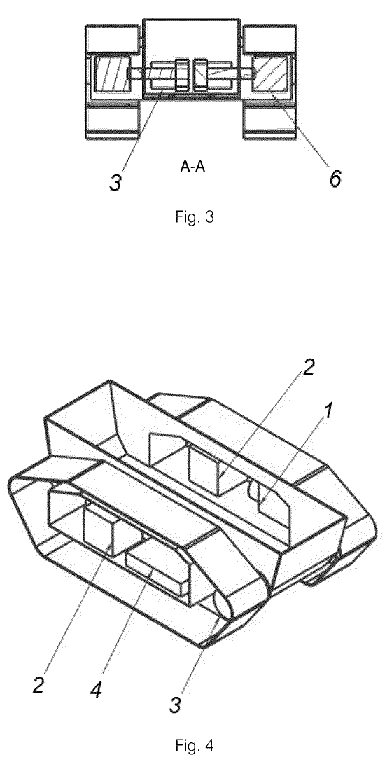

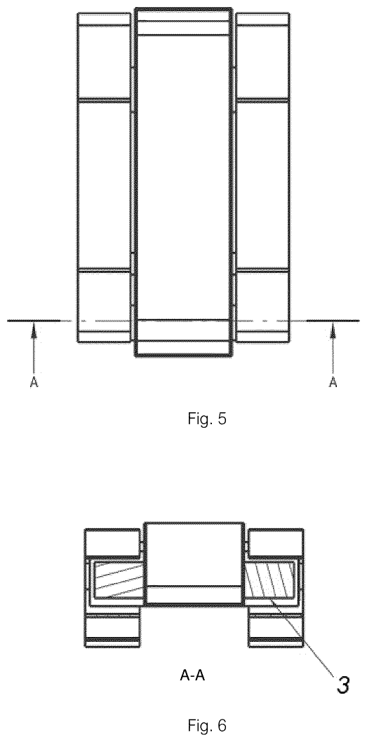

The power frame comprises a floor, roof and walls forming a common internal useful displacement volume combined with additional useful displacement volumes located on both sides of the common internal useful displacement volume in the caterpillar contour of the movers.

Wherein the traction electric motors 2 of both sides may be installed in the front part of the power frame in a block with gearboxes 5 and connected by the cardan drive to the driving wheel assembly 6 to organize the front drive of the caterpillar mover (FIG. 1,2,3) or may be installed outside the front part of the power frame and made directly as the electric motor wheels to serve as the driving wheels (FIG. 4,5,6).

The ICE generator 1 is installed entirely in the additional useful displacement volume of one of the caterpillar contours, while the energy accumulator 4 is installed entirely in the opposite useful displacement volume of the other caterpillar contour and, in terms of its weight, is equal to the ICE generator 1.

The gasoline tanks 2 are installed entirely in both useful displacement volumes of the caterpillar contours of the movers (i.e. one gasoline tank in one contour, and the other gasoline tank in the opposite contour), and have the same design, the same capacity and the same overflow system.

The energy accumulator is provided with BMS and thermal management unit 9. Such arrangement of the ICE generator, gasoline tanks and the energy accumulator is required, among other things, for increasing useful volume for fuel, expanding useful volume for crew and/or cargo, and improving weight distribution. Creating an ideal weight distribution provides a uniform bearing surface which, in the context of poorly bearing soils or on the water, improves such characteristics as cross-country ability and resistance to falling through the ice, and that, in turn, represents a tremendous advantage for any ATV. As the rechargeable battery has BMS and the thermal management unit, this may additionally ensure a reliable and long-term operation both for the battery and the entire transmission, allowing to travel on the ATV for an extended period, far away from filling stations and in any weather conditions.

The ICE generator 1, traction electric motors 3 with inverters 7 and energy accumulator 4 are electrically connected to each other through a high-voltage switching device 10 by means of a CAN bus and control wires. Only the traction electric motors/gearboxes are mechanically linked, while all other transmission elements are linked exclusively via CAN bus and control wires. Such simplicity of design (no multiple mechanical links and additional elements) ensures high reliability and serviceability, minimized maintenance, increased mileage between overhauls, reduced weight and dimensions of the ATV, as well as other advantages listed here.

High-voltage switching device 10 has an insulation monitoring system, which continuously measures the insulation resistance and sends the measurement values to the CAN bus.

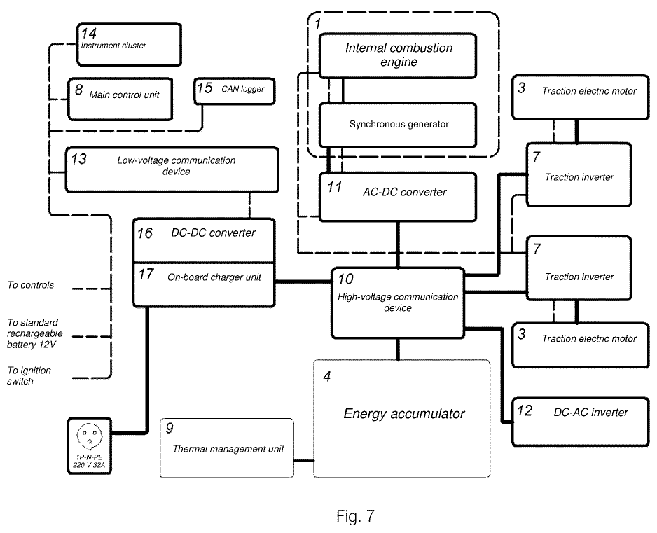

The diagram (FIG. 7) shows that the ICE generator 1 of the ATV is connected to the high-voltage switching device 10 through an AC-DC converter 11, wherein the high-voltage switching device 10 is additionally connected to a DC-AC inverter 12. In addition, the ATV is equipped with a low-voltage switching device 13, which is connected on the one side to the main control unit 8, instrument cluster 14, CAN logger 15, standard rechargeable battery, ignition switch and controls and, on the other side, to the high-voltage switching device 10 via a DC-DC converter 16 combined with the on-board charger unit 17 with output to a 220V outlet.

The high-voltage switching device (HVSD) is designed for the following:
Providing centralized connection for all high voltage units in the transmission;
Providing protection against high currents (fuses) for units without their own protection systems;
Providing its own insulation monitoring system, which continuously measures the insulation resistance and sends the measurement values to the CAN bus;
Providing the light indication of the status on the housing (ready/not ready).

The low-voltage switching device (LVSD) is designed for the following:
Providing centralized connection for all low-voltage devices and distributing electric power between low-voltage consumers of the electromechanical transmission in the ATV;
Connecting and disconnecting low-voltage consumers by a command from the main control unit.

The energy accumulator is designed for the following:
Providing efficient energy accumulation, storage and distribution between internal storage units (balancing the batteries) and stable energy output to consumers. It has a liquid circuit for connecting the cooling and heating system.

The thermal management unit for the energy accumulator is designed for the following:
Cooling the energy accumulator to operating temperature and preheating the energy accumulator at the engine start-up in sub-zero temperatures.

The main control unit (MCU) serves to control all elements of the electromechanical transmission. The MCU is connected to the units of all systems in the electromechanical transmission of the ATV over the digital communication bus and is designed for the following:
Providing the generation of control signals for all connected units;
Processing telemetry information;
Implementing preset control rules depending on the received information (regular and emergency algorithms);
Controlling the speed/torque of traction electric motors;
Controlling the charge/discharge current of the energy accumulator;
Controlling the power in the AC-DC converter of the generator;
Controlling on-board charger unit;
Distributing torque to the sides;
Controlling the thermal management unit of the accumulator;
Controlling the connection of consumers (e.g. cooling pumps and fans) via a low-voltage switching device;
Reducing the power of traction drives when the temperature of motors or invertors rises;
Reducing the currents or power of the AC-DC converter depending on the temperature of ICE, generator or the converter itself;
Reducing the charge-discharge currents of the accumulator depending on the allowable currents provided by the control system of the energy accumulator;
Ensuring the charging process of the energy accumulator when the ignition key is removed;
Ensuring the response of the control system in case of insulation faults based on insulation monitoring data in the HVSD;
Enabling the calibration of system parameters (e.g. maximum speed, maximum traction forces, steering coefficients, etc.) via a Windows application;
Processing signals from the fuel level sensor;
Processing signals from the ICE temperature sensor in case there is no temperature data in the CAN bus of the ICE control unit.

The data recording module for on-board CAN buses (CAN logger) is designed for the following:
Saving data of on-board CAN buses to non-volatile memory for a period of at least 24 hours in unprocessed format.

The instrument cluster is designed for the following:
Displaying up-to-date information on the status of electromechanical transmission components.

The drive mode selector is designed for the following:
Switching electromechanical transmission to forward/neutral/reverse mode

The traction electric motors are designed for the following:
Converting electrical energy into mechanical energy to propel the vehicle.

The traction invertors are designed for the following:
Ensuring continuous operation of traction electric motors at rated power over the entire range of operating voltages (operating charge level) provided by the energy accumulator.

The generator module consists of an internal combustion engine that rotates a synchronous permanent magnet AC generator and is designed for the following:

The AC-DC converter is designed for the following:
Converting the AC current produced by the generator module into DC current for the energy accumulator.

The DC-DC converter is designed for the following:
Reducing high-voltage DC voltage to 12-volt DC voltage to power on-board electrical instruments and charge the standard 12V battery.

The on-board charger unit is designed for the following:
Charging the energy accumulator from external sources.

The DC-AC inverter is designed for the following:
Converting high-voltage DC voltage into household AC power for household use.

The electronic sensor of the steering column is designed for the following:
Creating a signal for MCU, depending on the angle of steering column turn, to provide different speeds to traction electric motors when making a turn.

The common internal useful displacement volume combined with the additional useful displacement volume, which is located in the caterpillar contour of the movers, is fully protected against the penetration of dust and water.

This design enables the claimed ATV to drive off a geometrically challenging cross-country terrain (steep climbs, ravines, ice, etc.) using the operating principle of an electric locomotive (which can pull a tremendous mass of cargo). The property of the electric motor to create maximum torque on the shaft at a speed ranging from 0 km/h up to the maximum speed enables this ATV to overcome obstacles with maximum force at a minimum speed, which significantly improves the cross-country ability of this ATV compared to those with traditional transmission designs. Navigating extreme off-road conditions at a minimum speed significantly enhances the safety, comfort and protection of the ATV.

Among other things, the use of a generator with lower power to recharge the battery and its operation in the best efficiency mode increase the overall mileage of the ATV.

The use of the electric transmission allowed to avoid almost all mechanical links and enabled various layout solutions to evenly distribute weight, which is very important for any ATV when driving on a weak ground and on water. This design is versatile and, depending on the layout needs, it can provide front or rear wheel drive for a tracked ATV and ideal weight distribution for the vehicle.

ATV can also be used as a household power plant, when traveling far away from power sources.

In addition, the arrangement of ATV elements entirely in the undercarriage space will significantly expand the usable space of the vehicle, which in turn (by freeing up such space) will make this vehicle highly versatile and multi-purpose.

The use of electromechanical transmission will allow to produce an articulated tracked vehicle, which will significantly enhance cross-country ability when it comes to overcoming obstacles. This requires using a pivot ball hitch to couple the ATV with a similar vehicle that has an electromechanical transmission. Unlike in case of permanently articulated ATVs, this can be done only for a short period required to overcome challenging obstacles. The electric transmission of the claimed ATV has the best machine weight/drawbar pull ratio and is designed for driving the vehicle at high maximum speed due to the low weight of the entire structure and the use of an elaborate suspension.

The ATV described above has a simple and reliable design, as it is not laden with a large number of additional devices and has a minimum of mechanical links; at the same time, it has an improved and correct weight distribution, expanded usable space to accommodate the crew and/or cargo, and it can travel far away from filling stations in all weather conditions, with reduced mileage between overhauls and without requiring significant labor costs for repair and maintenance.

1. A small-sized tracked ATV with electromechanical transmission characterized in that it comprises a power frame, caterpillar movers, as well as the following installed on the power frame and connected to each other: an ICE generator, which is in turn connected to two gasoline tanks; two traction electric motors, each of which is connected to its own traction inverter; an energy accumulator and a control unit, wherein the power frame comprises a floor, a roof and walls forming a common internal useful displacement volume combined with additional useful displacement volumes located on both sides of the common internal useful displacement volume in the caterpillar contour of the movers, and the electric motors are installed in the front part of the power frame in a block with gearboxes and are connected by the cardan drive to the driving wheel assembly to organize the front drive of the caterpillar mover or are installed outside the front part of the power frame and are made directly as the electric motor wheels to serve as the driving wheels, with the ICE generator installed entirely in the additional useful displacement volume of one of the caterpillar contours, while the energy accumulator is installed entirely in the opposite useful displacement volume of the other caterpillar contour and, in terms of its weight, is equal to the ICE generator, wherein the gasoline tanks are installed entirely in both useful displacement volumes of the caterpillar contours of the movers, and have the same design, the same capacity and the same overflow system.

2. The small-sized tracked ATV with electromechanical transmission according to claim 1 characterized in that the ICE generator, traction electric motors and energy accumulator are electrically connected to each other through a high-voltage switching device by means of a CAN bus and control wires.

3. The small-sized tracked ATV with electromechanical transmission according to claim 2 characterized in that the high-voltage switching device has an insulation monitoring system, which continuously measures the insulation resistance and sends the measurement values to the CAN bus.

4. The small-sized tracked ATV with electromechanical transmission according to claim 1 characterized in that only two traction electric motors/gearboxes are mechanically linked, while all other transmission elements are linked exclusively via CAN bus and control wires.

5. The small-sized tracked ATV with electromechanical transmission according to claim 1 characterized in that the ICE generator is connected to the high-voltage switching device via an AC-DC converter.

6. The small-sized tracked ATV with electromechanical transmission according to claim 1 characterized in that a DC-AC inverter is further connected to the high-voltage switching device.

7. The small-sized tracked ATV with electromechanical transmission according to claim 1 characterized in that the energy accumulator has a Battery Management System (BMS).

8. The small-sized tracked ATV with electromechanical transmission according to claim 1 characterized in that the energy accumulator has a thermal management unit.

9. The small-sized tracked ATV with electromechanical transmission according to claim 1 characterized in that the ATV is further equipped with a low-voltage switching device, which is connected on the one side to the main control unit and controls and, on the other side, to the high-voltage switching device via a DC-DC converter combined with the on-board charger unit.

10. The small-sized tracked ATV with electromechanical transmission according to claim 1 characterized in that the common internal useful displacement volume combined with the additional useful displacement volume, which is located in the caterpillar contour of the movers, is fully protected against the penetration of dust and water.
